(19) United States
(12) Patent Application Publication
(10) Pub. No.: US 2012/0075288 A1
(43) Pub. Date: Mar. 29, 2012

(54) Apparatus and method for back-face culling using frame coherence

(75) Inventors: Won Jong Lee, Gangnam-gu (KR); Chan Min Park, Seoul (KR); Kyoung June Min, Yongin-si (KR)

(73) Assignee: SAMSUNG ELECTRONICS CO., LTD., Suwon-si (KR)

(21) Appl. No.: 13/067,555

(22) Filed: Jun. 8, 2011

(30) Foreign Application Priority Data
Sep. 24, 2010 (KR) 10-2010-0092874

(51) Int. Cl. G06T 15/00

(52) U.S. Cl. 345/419

(57) ABSTRACT

Disclosed are an apparatus and a method for back-face culling using coherence between chronologically adjacent frames. The apparatus and the method determine whether face properties of polygons are changed based on a matrix reflecting three-dimensional motion of a frame. When the face properties are not changed, face properties of the polygons used in a process of a previous frame are reused to cull back-face polygons.

### CROSS-REFERENCE TO RELATED APPLICATIONS

This application claims the priority benefit of Korean Patent Application No. 10-2010-0092874, filed on Sep. 24, 2010, in the Korean Intellectual Property Office, the disclosure of which is incorporated herein by reference.

### BACKGROUND

1. Field

One or more embodiments of the present disclosure relate to a method and an apparatus for efficient back-face culling using frame coherence.

More particularly, an image processing apparatus and an image processing method, each of which perform back-face culling with improved performance are disclosed.

2. Description of the Related Art

Back-face culling is a technique which determines early whether facets of an object are a visible front face or an invisible back face so as to prevent unnecessary rendering of invisible back faces.

Back-face culling is generally used in three-dimensional (3D) graphic applications.

Various operations may be used to determine whether polygons, for example, triangles, forming each object are front-faces or back-faces from a current viewpoint. Generally, the operations are complex and therefore use a substantial amount of resources.

### SUMMARY

The foregoing and/or other aspects are achieved by providing a three-dimensional (3D) graphic processing apparatus which processes at least one polygon in successive frames, the apparatus including a processor to control one or more processor-executable units, a recheck determination unit to determine whether to generate visibility information to sort polygons of a current frame into back-face polygons and front-face polygons, a visibility check unit to generate the visibility information of the current frame based on a decision of the recheck determination unit, and a culler to cull the back-face polygons among the polygons, wherein the culler determines the back-face polygons based on the visibility information of the current frame when the visibility information is generated and determines the back-face polygons based on visibility information of a previous frame when the visibility information is not generated.

The recheck determination unit may determine to generate the visibility information when the current frame is rotated on an x-axis or a y-axis with respect to the previous frame.

The recheck determination unit may determine whether to generate the visibility information based on a transformation matrix representing motion of the current frame.

The recheck determination unit may determine whether to generate the visibility information based on an element of the transformation matrix, the element having a value only by x-axis rotation or y-axis rotation.

The transformation matrix may be a 4×4 matrix including x, y, z, and w rows and x, y, z, and w columns, and the recheck determination unit may determine whether to generate the visibility information based on a (1,3) element, a (2,3) element, a (3,1) element, and a (3,2) element of the transformation matrix.

The visibility check unit may generate the visibility information based on a normal vector and a viewing vector of each of the polygons.

The visibility check unit may generate the visibility information based on depth information about each of the polygons.

The culler may output information to identify vertices forming the front-face polygons.

The 3D graphic processing apparatus may further include a vertex shader to perform a lighting process on the vertices based on the information to identify the vertices forming the front-face polygons.

According to another aspect of the example embodiments, there is provided a 3D graphic processing method which processes at least one polygon in successive frames, the method including determining, by way of a processor, whether to regenerate visibility information to sort polygons of a current frame into back-face polygons and front-face polygons, a visibility information regeneration process to regenerate the visibility information, and a visibility information reuse process to reuse visibility information used in a previous frame, wherein the visibility information regeneration process is performed when it is determined to regenerate the visibility information, and the visibility information reuse process is performed when it is determined not to regenerate the visibility information.

The recheck determination process may determine whether to regenerate the visibility information by checking whether the current frame is a first frame.

The recheck determination process may determine whether to regenerate the visibility information by checking whether the current frame is rotated on an x-axis or a y-axis with respect to the previous frame.

The visibility information regeneration process may generate the visibility information based on a normal vector and a viewing vector of each of the polygons.

The visibility information regeneration process may generate the visibility information based on depth information about each of the polygons.

The visibility information regeneration process may include a visibility information storage process to store generated visibility information, and a rendering determination process to determine whether to render the polygons based on the generated visibility information.

The visibility information reuse process may include a visibility information reference process to refer to stored visibility information, and a rendering determination process to determine whether to render the polygons based on the referred to visibility information.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a front face and a back face according to example embodiments;

FIG. 2 illustrates frame coherence according to example embodiments;

FIG. 3 illustrates a point of determining visibility in an image processing operation according to example embodiments;

FIG. 4 illustrates a method of calculating a facet normal according to example embodiments;

FIG. 5 illustrates a method of determining face properties of a polygon according to example embodiments;

FIG. 6 illustrates a change in visibility by a type of motion according to example embodiments;

FIG. 7 illustrates a transformation matrix representing motion to change visibility information according to example embodiments;

FIG. 8 illustrates a transformation matrix representing motion to maintain visibility information according to example embodiments;

FIG. 9 illustrates elements of a motion matrix to determine a possibility of a visibility change according to example embodiments;

FIG. 10 illustrates a configuration of a three-dimensional (3D) graphic processing apparatus according to example embodiments;

FIG. 11 illustrates a configuration of a 3D graphic processing apparatus according to other example embodiments; and

FIG. 12 is a flowchart illustrating a 3D graphic processing method according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

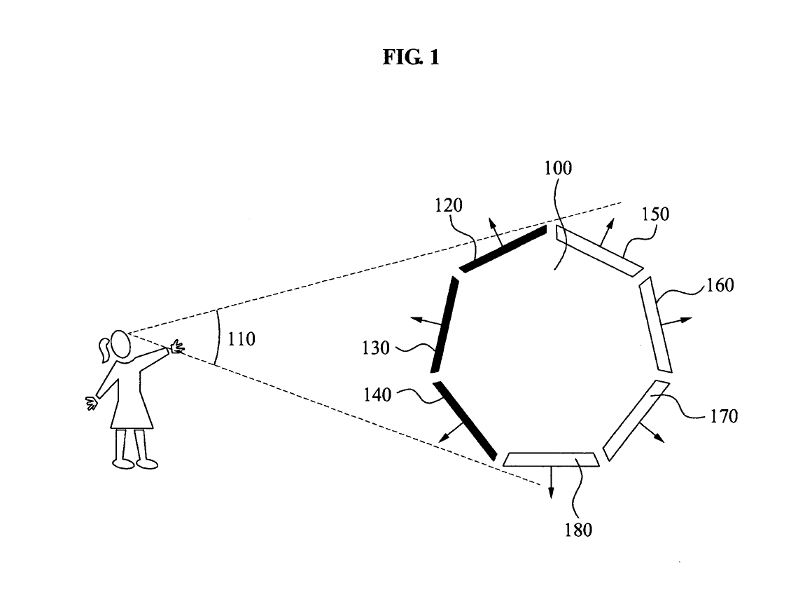

FIG. 1 illustrates a front face and a back face of an object according to example embodiments.

An example object 100 includes seven polygons 120, 130, 140, 150, 160, 170, and 180.

From a viewpoint 110 of an observer or a camera, three polygons 120, 130, and 140 are seen, and the other four polygons 150, 160, 170, and 180 are obstructed from view.

Here, the three polygons 120, 130, and 140 are front-faces, and the other four polygons 150, 160, 170, and 180 are back-faces.

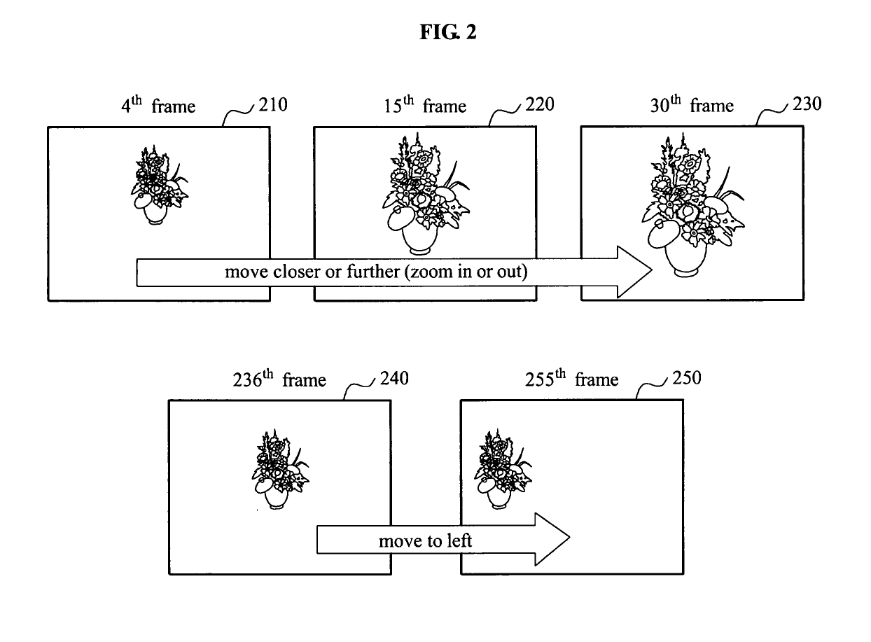

FIG. 2 illustrates frame coherence according to example embodiments.

Coherence may exist in a vertex or pixel value between chronologically successive frames to be rendered. Depending on characteristics of applications, triangles may have coherence in face properties.

Referring to FIG. 2, a fourth frame 210, a fifteenth frame 220, and a thirtieth frame 230 display various images corresponding to different viewpoints as a viewpoint of an observer moves closer or further away, that is, zooms in or out.

As shown in FIG. 2, when the view point moves closer or further away, polygons forming objects in the frames 210, 220, and 230 may be scaled up, and face properties of the polygons may be maintained the same. The face properties of the polygons denote whether the polygons are back-faces or front-faces.

A 236^{th} frame 240 and a 255^{th} frame 250 display images when the viewpoint of the observer moves to the left. In this instance, the face properties of the polygons in the images may be maintained the same.

Thus, when frames are generated based on motion, face properties of polygons generated in a process of a previous frame may be used in a process of a current frame instead of being recalculated, depending on a type of motion. Accordingly, redundant operations may be avoided thereby improving overall frame rendering performance.

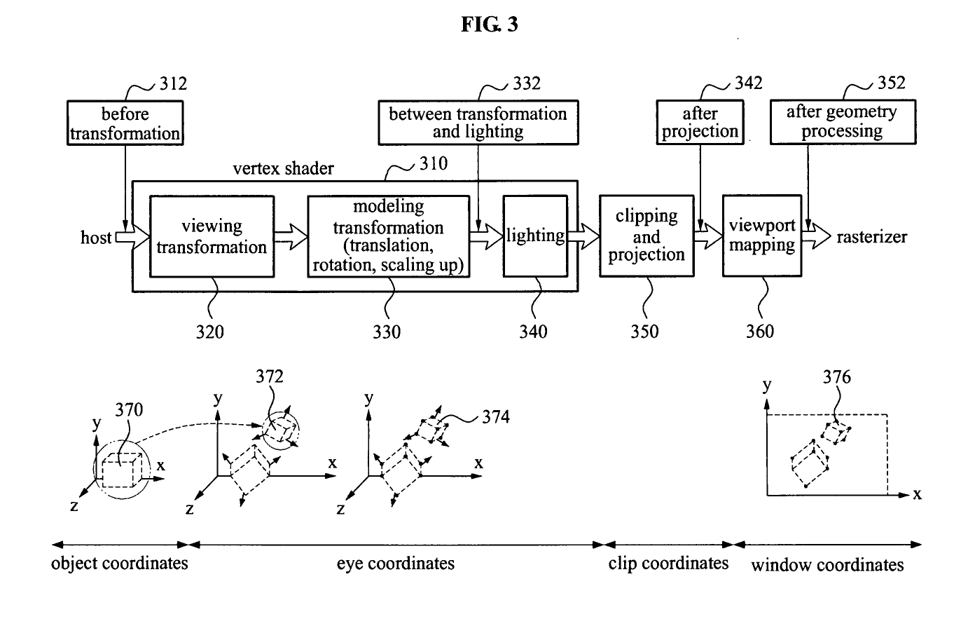

FIG. 3 illustrates a point of determining visibility in an image processing operation according to example embodiments.

Visibility denotes whether polygons forming objects are displayed within an image.

Visibility determination refers to determining visibility of a polygon. That is, visibility determination is determining face properties of the polygon.

The image processing operation 300 may include, for example, a vertex shader process 310, a clipping and projecting process 350, and a viewport mapping process 360.

The vertex shader process 310 performs a process by a vertex shader and may include, for example, a viewing transformation process 320, a modeling transformation process 330, and a lighting process 340.

The viewing transformation process 320 transforms object coordinates of vertices forming an object 370 into eye coordinates using information about the object 370 provided from a host.

The modeling transformation process 330 transforms coordinates of vertices forming a transformed object 372 based on motion of the transformed object 372, for example, translation, rotation, and scaling.

The lighting process 340 applies a lighting effect on a transformed object 374.

The clipping and projecting process 350 clips, that is, select, only an object to be displayed in an image among transformed objects 374, and transforms three-dimensional (3D) eye coordinates of the object or a vertex into two-dimensional (2D) clip coordinates.

The viewport mapping process 350 transforms the clip coordinates of the transformed object 374 into window coordinates.

Information about an object 376 having window coordinates is provided to a rasterizer.

Visibility determination may be performed before, after, or in between the above processes 320, 330, 340, 350, and 360. Hereinafter, an example of a point of determining visibility is described.

First visibility determination 312 may be performed before the viewing transformation process 320.

The first visibility determination 312 transforms an eye position into object coordinates and calculates a dot product of a viewing vector in the object coordinates and a facet normal of a polygon to determine visibility of the polygon.

Second visibility determination 332 is performed between the modeling transformation process 330 and the lighting process 340.

The second visibility determination 332 calculates a dot product of a viewing vector and a facet normal line of a polygon to determine visibility of the polygon and may omit lighting calculation on back-face polygons.

Third visibility determination 342 is performed between the projecting process 342 and the viewport mapping process 360, that is, after the projecting process 342 and before the viewport mapping process 360.

The third visibility determination 342 determines visibility of a polygon based on whether a normal line of the polygon faces a screen. Thus, only a z-component of a cross product is used. All vertices are transformed to a screen space.

Fourth visibility determination 352 is performed after the viewport mapping process 360, that is, after geometry processing.

The fourth visibility determination 352 checks clockwise or counter-clockwise order of vertices of a polygon to determine visibility of the polygon.

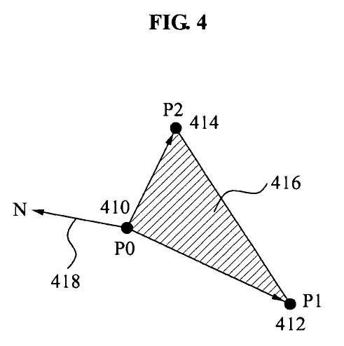

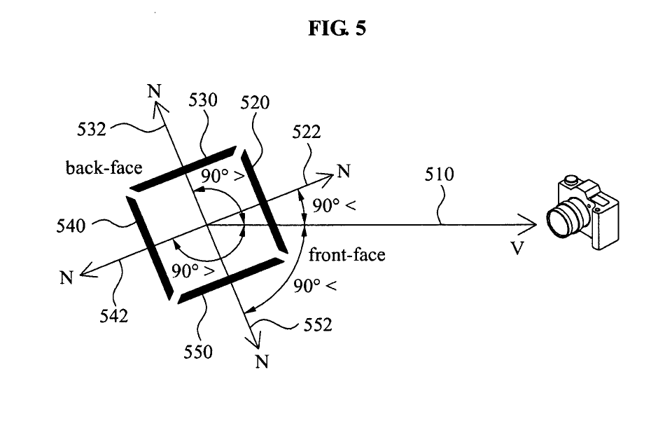

FIGS. 4 and 5 illustrate aspects of a method of determining visibility according to example embodiments.

FIG. 4 illustrates a method of calculating a facet normal according to example embodiments.

FIG. 4 shows a facet 416 of a polygon formed by three vertices, P₀ 410, P₁ 412, and P₂ 414. A normal line N 418, that is a line that is normal with respect to the facet 416, may be calculated by the following Equation 1.

N=(P₁−P₀)×(P₂−P₀) [Equation 1]

That is, the normal line 418 is a cross product of a vector from P₀ 410 to P₂ 414 and a vector from P₀ 410 to P₁ 412.

FIG. 5 illustrates a method of determining face properties of a polygon according to example embodiments.

FIG. 5 illustrates an object including a viewing vector V 510 and four polygons, including a polygon 520, a polygon 530, a polygon 540, and a polygon 550. Two polygons, the polygon 520 and the polygon 550, are front-faces, and two polygons, the polygon 530 and the polygon 540 are back-faces.

Whether the respective four polygons, polygon 520, polygon 530, polygon 540, and polygon 550, are front-face polygons or back-face polygons may be determined by a dot product N•V of the viewing vector V 510 and a respective normal line, that is, normal line 532, normal line 542, normal line 552, or normal line 562, of the polygons. That is, a dot product has a value of a cosine of θ, θ being an angle between the viewing vector V 510 and normal line 532, normal line 542, normal line 552, or normal line 562, of the respective polygons.

When θ is from +90° to −90°, the polygon is front-face. Otherwise, the polygon is back-face. That is, when a dot product of the viewing vector V 510 and the respective normal line being the normal line 532, the normal line 542, the normal line 552, or the normal line 562 of the polygons is less than 0, the polygon is back-face. Otherwise, the polygon is front-face.

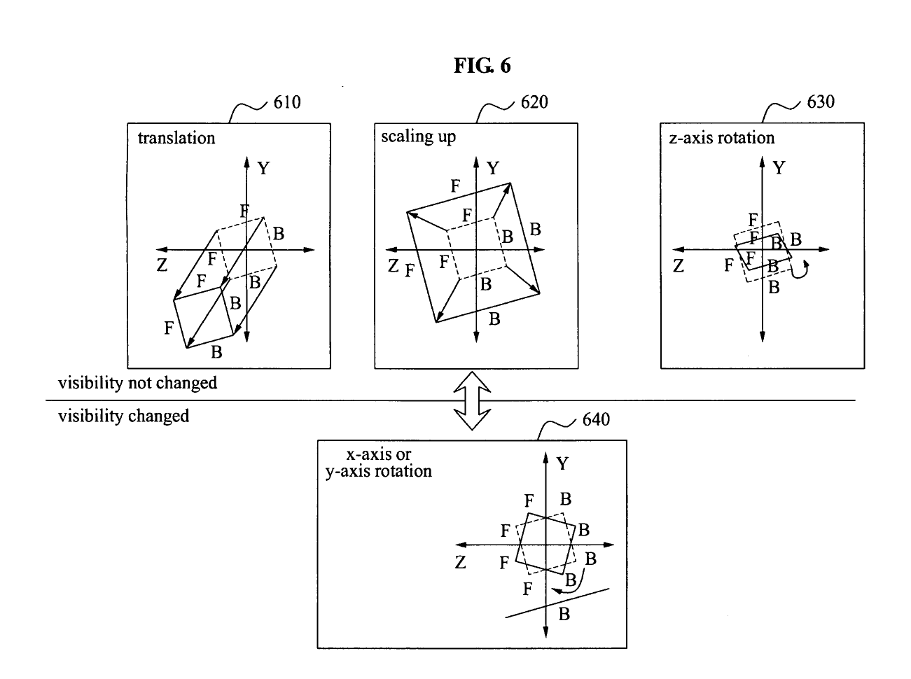

FIG. 6 illustrates a change in visibility according to a type of motion according to example embodiments.

Coordinates of vertices forming a polygon are changed to reflect motion. One type of motion changes coordinates of vertices, however, visibility of a polygon formed by the vertices remains unchanged. Another type of motion changes coordinates of vertices, however, visibility of a polygon formed by the vertices changes.

The type of motion for which visibility of a polygon remains unchanged is illustrated in an upper part of FIG. 6.

That is, when coordinates of vertices are changed to reflect motion, such as translation 610, scaling up 620, or z-axis rotation 630, visibility of a polygon formed by the vertices is unchanged.

The type of motion for which visibility of a polygon is changed is shown in a lower part of FIG. 6.

That is, when coordinates of vertices are changed to reflect motion, such as x-axis or y-axis rotation 640, visibility of a polygon formed by the vertices may be changed. That is, the polygon may be changed from a back-face to a front-face or from a front-face to a back-face.

Motion is made in a frame unit. Thus, if motion of a current frame is identified when compared with a previous frame, whether visibility of polygons in the frame is maintained may be determined.

When the motion of the current frame maintains the visibility of the polygons the same, the visibility of the polygons in the current frame is not redundantly calculated, and information about visibility of the polygons in the previous frame may be used.

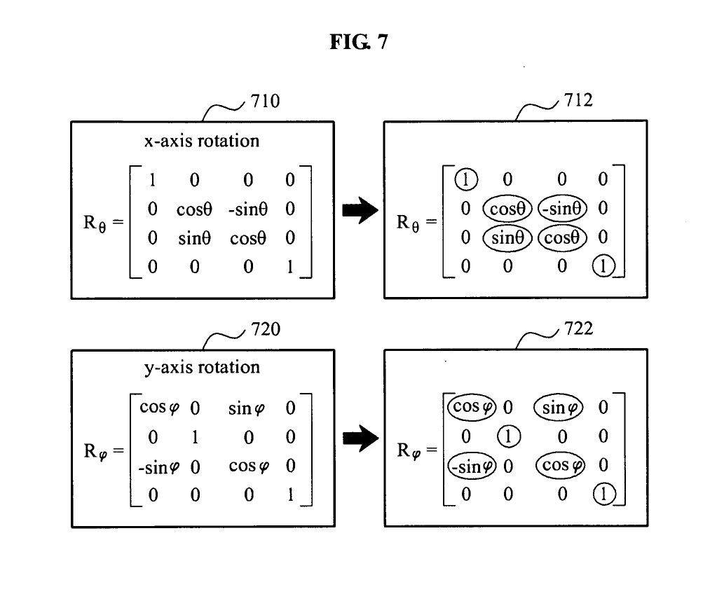

FIGS. 7 to 9 illustrate inter-frame coherence according to example embodiments.

That visibility of polygons in a frame is maintained the same with respect to a first frame and a second frame, which are chronologically adjacent is highly probable. The above characteristic of visibility of a polygon is typically referred to as inter-frame coherence.

In order to determine whether visibility of polygons in a current frame is maintained the same it should be determined whether motion occurring in the current frame includes x-axis or y-axis rotation.

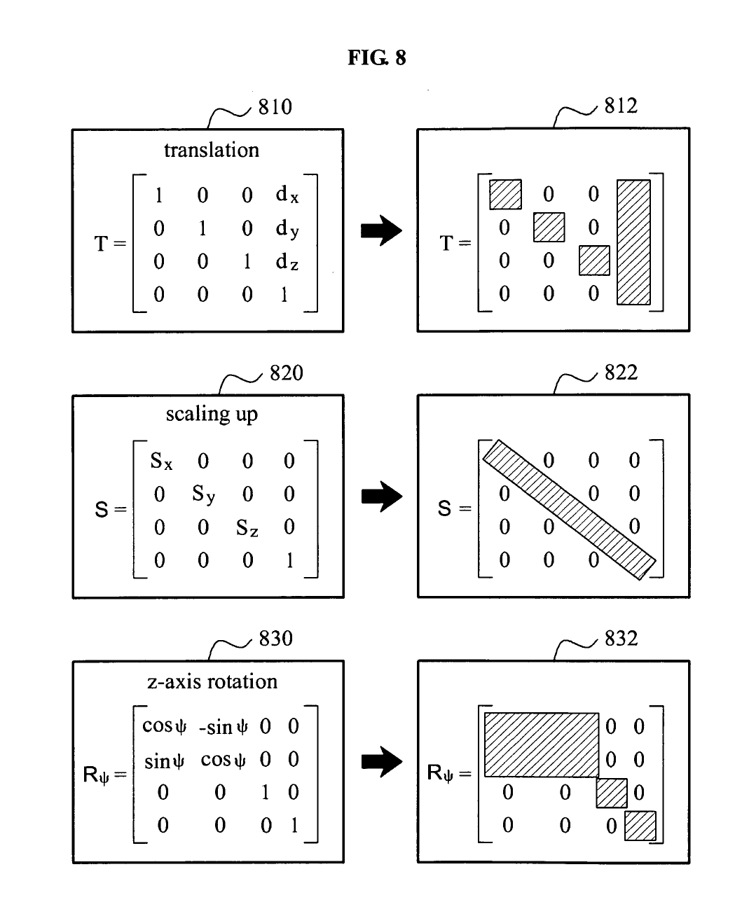

Motion of a frame may be expressed by a modelview matrix, which is described with reference to FIGS. 7 and 8.

The modelview matrix is a 4×4 matrix including x, y, z, and w rows and x, y, z, and w columns. Here, x, y, and z respectively correspond to an x-axis, a y-axis, and a z-axis, and w refers to a row or column used to transform a vertex using a matrix multiplication.

A matrix obtained by multiplying the modelview matrix and a matrix representing a coordinate of a vertex, that is, the coordinate of the vertex in a previous frame, is a new coordinate of the vertex, that is, the coordinate of the vertex in the current frame.

Thus, when an element having a value other than 0 exists among elements of the modelview matrix only in the case where the modelview matrix represents x-axis rotation and y-axis rotation, elements are checked. Here, when all of the elements have a value of 0, visibility of polygons is determined to be maintained the same. Thus, the visibility of the polygons is not calculated, and visibility information generated in a process of the previous frame may be reused as visibility information for the current frame.

FIG. 7 illustrates a transformation matrix representing motion to change visibility information according to example embodiments.

R_{θ} 710 is a transformation matrix representing x-axis rotation. θ is a rotation angle. Among elements of the transformation matrix, elements which may have a value other than 0 when x-axis rotation is performed are circled in a descriptive transformation matrix 712.

R_{φ} 720 is a transformation matrix representing y-axis rotation. φ is a rotation angle. Among elements of the transformation matrix, elements which may have a value other than 0 when y-axis rotation is performed are circled in a descriptive transformation matrix 722.

Thus, in order to determine whether motion of the current frame includes x-axis rotation or y-axis rotation, a value of at least one of the circled elements in a right part of FIG. 7 is checked. However, elements which may have a value other than 0 also by different motion, such as translation, scaling up, or z-axis rotation, among the elements are excluded.

FIG. 8 illustrates a transformation matrix representing motion to maintain visibility information according to example embodiments.

T 810 is a transformation matrix representing translation. Here, dₓ, d_{y}, and d_{z} respectively refer to a degree of translation with respect to each of an x-axis, a y-axis, and a z-axis. Among elements of the transformation matrix 810, elements which may have a value other than 0 when translation is performed are masked in a descriptive transformation matrix 812.

S 820 is a transformation matrix representing scaling up. Here, Sₓ, S_{y}, S_{Z} respectively refer to a degree of scaling up with respect to each of an x-axis, a y-axis, and a z-axis. Among elements of the transformation matrix 820, elements which may have a value other than 0 when scaling up is performed are masked in a descriptive transformation matrix 822.

R_{ψ} 830 is a transformation matrix representing z-axis rotation. ψ is a rotation angle. Among elements of the transformation matrix 830, elements which may have a value other than 0 when z-axis rotation is performed are masked in a descriptive transformation matrix 832.

The masked elements in a right part of FIG. 8 may have a value other than 0 even without x-axis rotation or y-axis rotation. Thus, elements masked in any one of the three motion matrices may not be used to determine whether the visibility information is maintained to be the same.

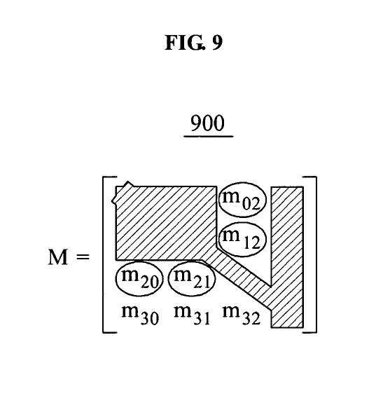

FIG. 9 illustrates elements of a motion matrix to determine a possibility of a visibility change according to example embodiments.

Masked elements in FIG. 9 are elements masked in at least one of the transformation matrices of FIG. 8. The masked elements may not be used to determine a possibility of a visibility change.

Further, to determine a possibility of a visibility change, circled elements in at least one of the transformation matrices of FIG. 7 are used. The elements are circled in FIG. 9.

Thus, a (1,3) element, a (2,3) element, a (3,1) element, and a (3,2) element of the transformation matrix represent whether there is a possibility of a visibility change. When at least one of the above elements has a value other than 0, the transformation matrix may represent x-axis rotation or y-axis rotation. Thus, in this instance, visibility information generated in a previous frame may not be reused in a current frame.

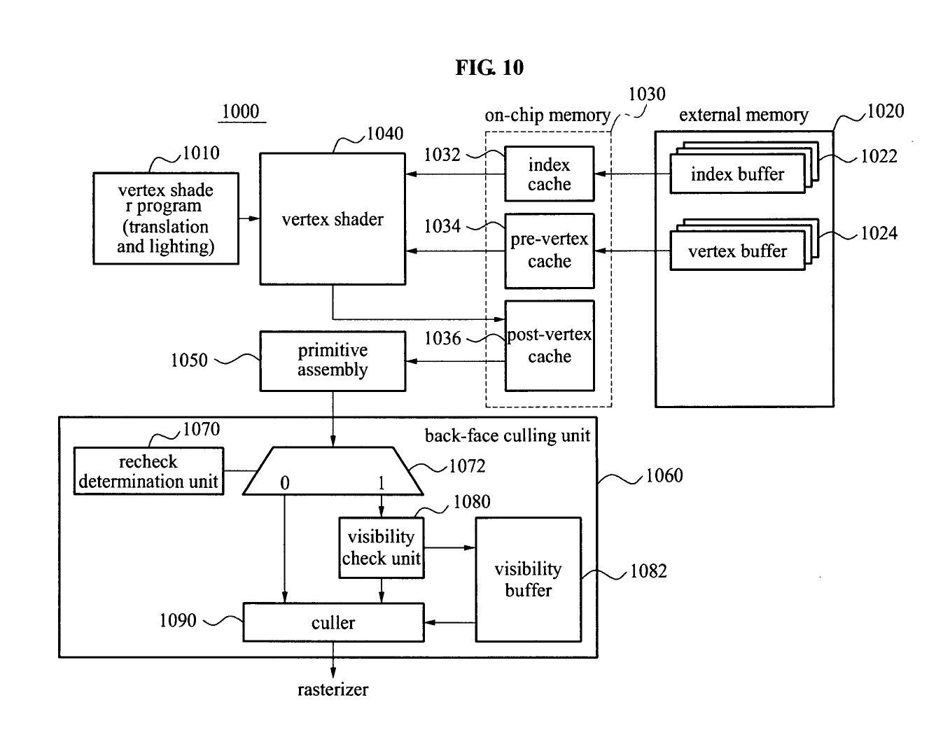

FIG. 10 illustrates an exemplary configuration of a three-dimensional (3D) graphic processing apparatus 1000 according to example embodiments.

The 3D graphic processing apparatus 1000 processes at least one vertex, primitive, or polygon in successive frames. The 3D graphic processing apparatus 1000 may perform back-face culling after a geometric process terminates.

The 3D graphic processing apparatus 1000 may include, for example, an external memory 1020, an on-chip memory 1030, a vertex shader 1040, a primitive assembly unit 1050, and a back-face culling unit 1060.

The external memory 1020 may include, for example, an index buffer 1022 and a vertex buffer 1024.

The vertex buffer 1024 stores information about vertices in a frame.

The index buffer 1022 stores information about indices in a frame. The indices are information representing a polygon in a frame and may include a list of at least one vertex.

The external memory 102 provides the index information and the vertex information to the on-chip memory 1030.

The on-chip memory 1030 may include, for example, an index cache 1032, a pre-vertex cache 1034, and a post-vertex cache 1036.

The index cache 1032 is provided with the index information from the index buffer 1022.

The pre-vertex cache 1034 is provided with the vertex information from the vertex buffer 1024.

The post-vertex cache 1036 is provided with the vertex information from the vertex shader 1040.

A vertex shader program 1010 is input to the vertex shader 1040. The vertex shader program 1010 may be a program to process translation and lighting.

The vertex shader 1040 applies a process represented by the vertex shader program 1010 to a vertex based on the index information provided by the index cache 1032 and the vertex information provided by the pre-vertex cache 1034. The above process may be application of a transformation matrix based on motion of a frame to the vertex. The vertex is transformed by the vertex shader 1140, and information about the transformed vertex is stored in the post-vertex cache 1036.

The primitive assembly 1050 is provided with the changed vertex information from the post-vertex cache 1036 and forms the information into a viable primitive, for example, a polygon.

The back-face culling unit 1060 is provided with information about the primitive from the primitive assembly 150 and may eliminate a back-face polygon in a current frame.

The back-face culling unit 1060 may include, for example, a recheck determination unit 1070, a switch 1072, a visibility check unit 1080, a visibility buffer 1082, and a culler 1090.

The recheck determination unit 1070 determines whether to generate visibility information. That is, the recheck determination unit 1070 determines whether to reuse visibility information of polygons generated in a process of a previous frame or to regenerate the visibility information of the polygons.

When the current frame is a first frame, the recheck determination unit 1070 determines whether to generate visibility information.

The recheck determination unit 1070 may determine to generate the visibility information when the current frame is rotated on the x-axis or the y-axis with respect to the previous frame.

The recheck determination unit 1070 may determine whether to generate the visibility information based on a transformation matrix representing motion of the current frame.

The recheck determination unit 1070 may determine whether to generate the visibility information based on an element among the transformation matrix. In an embodiment, the element may have value only by x-axis rotation or y-axis rotation.

The transformation matrix may be the 4×4 matrix including x, y, z, and w rows and x, y, z, and w columns, described above with reference to FIG. 9. The recheck determination unit 170 may determine whether to generate the visibility information based on the (1,3) element, the (2,3) element, the (3,1) element, and the (3,2) element of the transformation matrix.

The switch 1072 provides information from the primitive assembly 1050 to the culler 1090 when the recheck determination unit 1070 determines not to perform rechecking. Also, the switch 1072 provides the information from the primitive assembly 1050 to the visibility check unit 1080 when the recheck determination unit 1070 determines to perform rechecking.

The visibility check unit 1080 determines visibility of polygons using the provided information about primitives based on a decision of the recheck determination unit 1070.

The visibility check unit 1080 may sort at least one polygon in the current frame into front-face polygons and back-face polygons. The visibility check unit 1080 may generate information representing face properties of each of the at least one polygons. The visibility information generated by the visibility check unit 1080 is stored in the visibility buffer 1082.

The visibility check unit 1080 may generate the visibility information based on the visibility determination processes, that is, the first visibility determination 312, the second visibility determination 332, the third visibility determination 334, and the fourth visibility determination 352, described above with reference to FIG. 3.

The visibility check unit 1080 may generate the visibility information based on a normal vector and a viewing vector of each of the at least one polygon.

The visibility check unit 1080 may generate the visibility information based on depth information about each of the at least one polygon.

When the visibility check unit 1080 generates the visibility information in the process of the current frame, the visibility buffer 1082 updates stored visibility information with respect to the current frame. When the visibility check unit 1080 does not generate visibility information in the process of the current frame, the visibility buffer 1082 maintains the visibility information about the previous frame which has already been generated.

The culler 1090 is provided with information about the polygons from the switch 1072 or the visibility check unit 1080. The culler 1090 is provided with the visibility information about the polygons from the visibility buffer 1082.

The culler 1090 culls the back-face polygons based on the visibility information and provides a culling result to the rasterizer.

As described above with respect to the visibility buffer 1082, the culler 1090 determines the back-face polygons based on the visibility information when the visibility information about the current frame is generated. Further, the culler 1090 determines the back-face polygons based on the visibility information about the previous frame stored in the visibility buffer 1082 when the visibility information is not generated.

The example embodiments described above with reference to FIGS. 1 to 9 may be applied to the present example embodiments. Thus, redundant descriptions are omitted herein for clarity and conciseness.

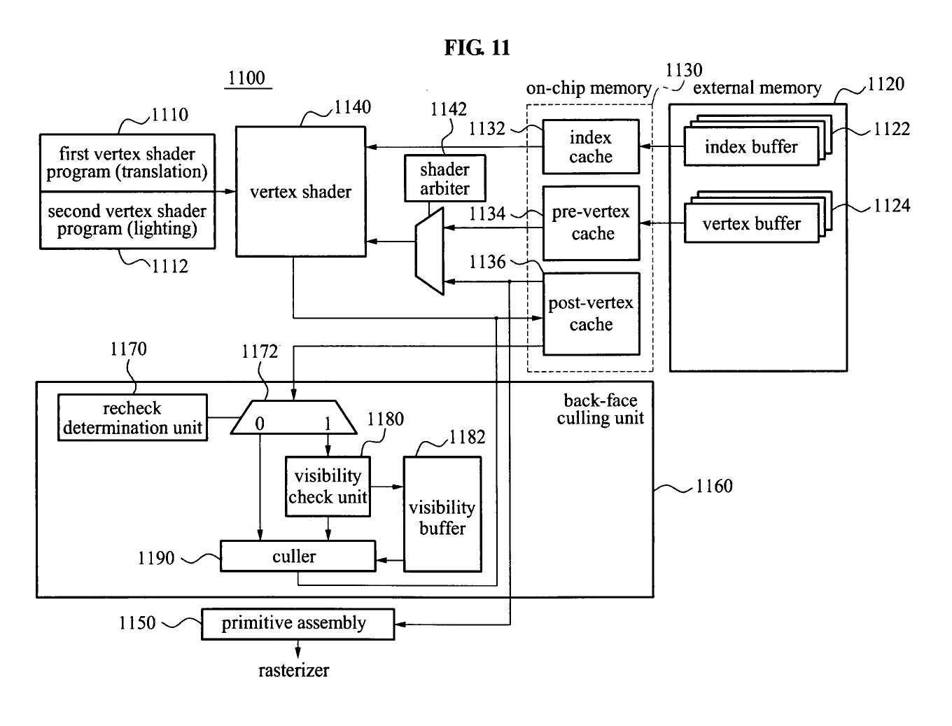

FIG. 11 illustrates a configuration of a 3D graphic processing apparatus according to other example embodiments.

Components 1110 to 1190 of the 3D graphic processing apparatus 1100 are similar to the components 1010 to 1090 of the 3D graphic processing apparatus 1000 described above with reference to FIG. 10. Thus, differences between the apparatuses 1000 and 1100 are in the present embodiments.

In the present embodiments, back-face culling is performed between a process of a first vertex shader program 1110 and a process of a second vertex shader program 1112. the first vertex shader program 1110 represent a translation process on a vertex, and the second vertex shader program 1112 represents a lighting process on a vertex.

Thus, a first operation to process the first program and a second operation to process the second program may be distinguished depending on a program processed by a vertex shader 1140.

In the first operation, a shader arbiter 1142 provides vertex information in a pre-vertex cache 1134 to the vertex shader 1140. The vertex shader 1140 applies a translation effect of the first program to a vertex using the vertex information. Information about the transformed vertex is stored in a post-vertex cache 1136.

A back-face culling unit 1160 performs back-face culling using the information in the post-vertex cache 1136 as information is not provided from a primitive assembly 1150.

A back-face culling result is stored in the post-vertex cache 1136.

A culler 1190 may output information to identify vertices forming front-face polygons to the post-vertex cache 1136. Vertices only associated with back-face polygons are not displayed within an image, and thus a lighting process is not performed on the vertices.

Vertices forming at least one front-face polygon may be displayed in the image. Thus, a lighting process is performed on the vertices.

The culler 1190 may output the vertices forming the at least one front-face polygon or information about the vertices to the post-vertex cache 1136.

In the second operation, the shader arbiter 1142 provides vertex information in the post-vertex cache 1136 to the vertex shader 1140. The vertex information in the post-vertex cache 1136 includes the information provided from the culler 1190 in the first operation. Thus, the vertex shader 1140 may identify vertices not culled and perform a lighting process only on the vertices based on the second program.

The vertices on which the lighting process is performed by the vertex shader 1140 are output to the primitive assembly 1150.

The example embodiments described above with reference to FIGS. 1 to 10 may be applied to the present example embodiments. Thus, detailed descriptions are omitted herein for clarity and conciseness.

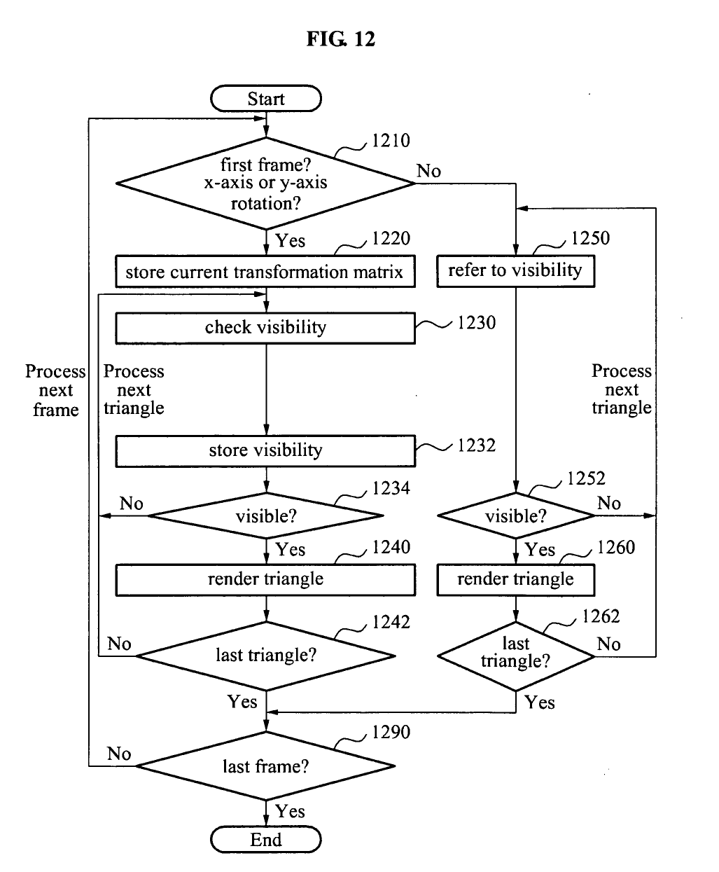

FIG. 12 is a flowchart illustrating a 3D graphic processing method according to example embodiments.

In a recheck determination process of operation 1210, it is determined whether to regenerate visibility information. The visibility information is information to sort polygons, for example, triangles, in a current frame into back-face polygons and front-face polygons.

When the visibility information is determined to be regenerated, a visibility information regeneration process of operations 1220 to 1242 is performed. When the visibility information is determined not to be regenerated, a visibility information reuse process of operations 1250 to 1262 is performed.

The recheck determination process of operation 1210 may determine whether to regenerate the visibility information by checking whether the current frame is a first frame.

The recheck determination process of operation 1210 may determine whether to regenerate the visibility information by checking whether the current frame is rotated on an x-axis or a y-axis with respect to a previous frame.

The recheck determination process of operation 1210 may determine whether to regenerate the visibility information based on a transformation matrix representing motion of the current frame, and may determine whether to regenerate the visibility information based on an element in the transformation matrix. In an embodiment, the element has a value only by x-axis rotation or y-axis rotation.

A transformation matrix may be a 4×4 matrix including x, y, z, and w rows and x, y, z, and w columns, and the recheck determination process of operation 1210 may determine whether to generate the visibility information based on a (1,3) element, a (2,3) element, a (3,1) element, and a (3,2) element of the transformation matrix.

The visibility information regeneration process of operations 1220 to 1242 regenerates the visibility information and renders polygons using the generated visibility information.

In operation 1220, the transformation matrix in the current frame is stored. The stored transformation may be used in another subsequent process.

In operation 1230, visibility of a polygon is checked. That is, visibility information about the polygon is regenerated.

The visibility information may be generated based on a normal vector and a viewing vector of the polygon.

The visibility information may be generated based on depth information about the polygon.

In a visibility information storage process of operation 1232, the generated visibility information about the polygon is stored in a buffer and the like to be reused in processing subsequent frames.

In a rendering determination process of operation 1234, whether the polygon is visible is determined based on the generated visibility information.

When the polygon is not visible, that is, when the polygon is a back-face polygon, operation 1230 is performed to process a next polygon. When the current polygon is a last polygon, operation 1290 may be performed.

When the polygon is visible, that is, when the polygon is front-face polygon, operation 1240 of rendering the polygon is performed.

In operation 1240, the visible polygon is rendered.

In operation 1242, whether the current polygon is a last polygon is determined. When the polygon is not the last polygon, operation 1230 is performed to process a next polygon. When the current polygon is the last polygon, operation 1290 is performed.

In a visibility information reuse process of operations 1250 to 1262, visibility information used in the previous frame is reused to determine whether to render polygons.

In a visibility information reference process of operation 1250, the visibility information about polygons stored in a buffer and the like in a process of the previous frame is referred to or loaded in order to process a polygon in the current frame.

In a rendering determination process of operation 1252, it is determined whether the polygon is visible based on the referred to visibility information.

When the polygon is not visible, that is, when the polygon is back-face polygon, operation 1250 is performed to process a next polygon. When the current polygon is a last polygon, operation 1290 may be performed.

When the polygon is visible, that is, when the polygon is front-face polygon, operation 1260 of rendering the polygon is performed.

In operation 1260, the visible polygon is rendered.

In operation 1262, whether the current polygon is a last polygon is determined. When the polygon is not the last polygon, operation 1250 is performed to process a next polygon. When the current polygon is the last polygon, operation 1290 is performed.

In operation 1290, whether the current frame is a last frame is checked. When the current frame is different from the last frame, operation 1210 is performed to process a next frame. When the current frame is the last frame, the process terminates.

The example embodiments described above with reference to FIGS. 1 to 11 may be applied to the present example embodiments. Thus, redundant descriptions are omitted herein for clarity and conciseness.

The apparatuses and the methods for back-face culling using frame coherence according to the above-described embodiments may be recorded in non-transitory computer-readable media including program instructions to implement various operations embodied by a computer. The media may also include, alone or in combination with the program instructions, data files, data structures, and the like.

Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a dedicated processor unique to that unit or by a processor common to one or more of the modules. The described methods may be executed on a general purpose computer or processor or may be executed on a particular machine such as the 3D graphic processing apparatus described herein.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A three-dimensional (3D) graphic processing apparatus which processes at least one polygon in successive frames, the apparatus comprising:
a processor to control one or more processor-executable units;
a recheck determination unit to determine whether to generate visibility information to sort polygons of a current frame into back-face polygons and front-face polygons;
a visibility check unit to generate the visibility information of the current frame based on a decision of the recheck determination unit; and
a culler to cull the back-face polygons among the sorted polygons, wherein the culler determines the back-face polygons based on the visibility information of the current frame when the visibility information is generated and determines the back-face polygons based on visibility information of a previous frame when the visibility information is not generated.

2. The apparatus of claim 1, wherein the recheck determination unit determines to generate the visibility information when the current frame is rotated on an x-axis or a y-axis with respect to the previous frame.

3. The apparatus of claim 1, wherein the recheck determination unit determines whether to generate the visibility information based on a transformation matrix representing motion of the current frame.

4. The apparatus of claim 3, wherein the recheck determination unit determines whether to generate the visibility information based (man element of the transformation matrix, the element having a value only by x-axis rotation or y-axis rotation.

5. The apparatus of claim 3, wherein the transformation matrix is a 4×4 matrix including x, y, z, and w rows and x, y, z, and w columns, and the recheck determination unit determines whether to generate the visibility information based on a (1,3) element, a (2,3) element, a (3,1) element, and a (3,2) element of the transformation matrix.

6. The apparatus of claim 1, wherein the visibility check unit generates the visibility information based on a normal vector and a viewing vector of each of the polygons.

7. The apparatus of claim 1, wherein the visibility check unit generates the visibility information based on depth information about each of the polygons.

8. The apparatus of claim 1, wherein the culler outputs information to identify vertices forming the front-face polygons.

9. The apparatus of claim 8, further comprising a vertex shader to perform a lighting process on the vertices based on the information to identify the vertices forming the front-face polygons.

10. A three-dimensional (3D) graphic processing method which processes at least one polygon in successive frames, the method comprising:
determining, by way of a processor, whether to regenerate visibility information to sort polygons of a current frame into back-face polygons and front-face polygons;
a visibility information regeneration process to regenerate the visibility information; and
a visibility information reuse process to reuse visibility information used in a previous frame,
wherein the visibility information regeneration process is performed when it is determined to regenerate the visibility information, and the visibility information reuse process is performed when it is determined not to regenerate the visibility information.

11. The method of claim 10, wherein in the determining of whether to regenerate the visibility information, it is checked whether the current frame is a first frame to determine whether to regenerate the visibility information.

12. The method of claim 10, wherein in the determining of whether to regenerate the visibility information, it is checked whether the current frame is rotated on an x-axis or a y-axis with respect to the previous frame.

13. The method of claim 10, wherein the determining of whether to regenerate the visibility information includes determining whether to generate the visibility information based on a transformation matrix representing motion of the current frame.

14. The method of claim 13, wherein the determining of whether to regenerate the visibility information is based on an element of the transformation matrix, the element having a value only by x-axis rotation or y-axis rotation.

15. The method of claim 13, wherein the transformation matrix is a 4×4 matrix including x, y, z, and w rows and x, y, z, and w columns, and the recheck determination process determines whether to generate the visibility information based on a (1,3) element, a (2,3) element, a (3,1) element, and a (3,2) element of the transformation matrix.

16. The method of claim 10, wherein the visibility information regeneration process generates the visibility information based on a normal vector and a viewing vector of each of the polygons.

17. The method of claim 10, wherein the visibility information regeneration process generates the visibility information based on depth information about each of the polygons.

18. The method of claim 10, wherein the visibility information regeneration process comprises:
a visibility information storage process to store generated visibility information; and
a rendering determination process to determine whether to render the polygons based on the generated visibility information.

19. The method of claim 10, wherein the visibility information reuse process comprises:
a visibility information reference process to refer to stored visibility information; and
a rendering determination process to determine whether to render the polygons based on the referred to visibility information.

20. A non-transitory computer-readable medium comprising a program for instructing a computer to perform the method of claim 10.

21. A three-dimensional (3D) graphic processing apparatus which processes at least one polygon of an object in successive frames, the apparatus comprising:
a processor to control one or more processor-executable units;
a recheck determination unit to determine whether motion of an object in a current frame includes rotation of the object along a particular axis of the object with respect to a previous frame; and
a visibility check unit to regenerate visibility information of the object in the current frame when the motion includes the rotation of the object along the particular axis in the current frame and otherwise to reuse, from the previous frame, the visibility information of the object generated in the previous frame.

22. The apparatus of claim 21, wherein the recheck determination unit determines whether the motion of the object in the current frame includes x-axis or y-axis rotation of the object with respect to the previous frame.

23. A three-dimensional (3D) graphic processing method which processes at least one polygon of an object in successive frames, the method comprising:
determining, by way of a processor, whether motion of an object in a current frame includes rotation of the object along a particular axis of the object with respect to a previous frame; and
regenerating visibility information of the object in the current frame when the motion includes the rotation of the object along the particular axis in the current frame and otherwise reusing, from the previous frame, the visibility information of the object generated in the previous frame.

24. The method of claim 23, wherein the determining includes determining whether the motion of the object in the current frame includes x-axis or y-axis rotation of the object with respect to the previous frame.

25. A non-transitory computer-readable medium comprising a program for instructing a computer to perform the method of claim 23.
